(19) United States
(12) Patent Application Publication
(10) Pub. No.: US 2015/0259225 A1
(43) Pub. Date: Sep. 17, 2015

(54) Ion separation device and method formed by magnetic field and ion exchange membranes

(71) Applicant: Runxi SU, Tianjin (CN)

(72) Inventor: Runxi Su, Tianjin (CN)

(21) Appl. No.: 14/434,095

(22) PCT Filed: Sep. 25, 2013
(86) PCT No.: PCT/CN2013/084222

§ 371 Date: Apr. 7, 2015

(30) Foreign Application Priority Data
Oct. 10, 2012 (CN) 201210382278.0

(51) Int. Cl. C02F 1/469

(52) U.S. Cl. CPC C02F 1/4695; C02F 2103/08

(57) ABSTRACT

The present invention discloses an ion separation device formed by a magnetic field and ion exchange membranes, comprising a magnetic field, anion exchange membranes (3, 10) and cation exchange membranes (4, 9), a main fluid flowing partition, a forward main fluid passage, a reverse main fluid passage and side solution passages. The present invention also discloses an ion separation method formed by a magnetic field and ion exchange membranes: in the presence of a magnetic field, anions of a flowing electrolyte solution pass through the anion exchange membranes (3, 10) while cations of the flowing electrolyte solution pass through the cation exchange membranes (4, 9), cations of an electrolyte solution in the adjacent passages pass through the cation exchange membranes (4, 9) while anions of the electrolyte solution in the adjacent passages pass through the anion exchange membranes (3, 10), and finally electrical property neutralization is respectively completed in the high-concentration solution on two sides. The ion separation device and the ion separation method are applicable to seawater desalination and ion separation of an electrolyte-containing solution, and continuous operation can be achieved without regeneration and desorption.

### FIELD OF THE INVENTION

The present invention belongs to the technical field of ion separation of an electrolyte solution, and particularly relates to a device for implementing ion separation by using ion selectivity of anion and cation exchange membranes transmitting charged ions and the electromagnetic induction separation principle of anion and cation reverse transfer technology of moving conductive fluid conductors under magnetic induction, and an operation method thereof.

### BACKGROUND OF THE INVENTION

There are mainly two kinds of aqueous solution electrolyte desalination technologies at present: I, solvent water is extracted from a solution, e.g. reverse osmosis technology and thermal distillation technology; and II, solvend is separated from a solution, e.g. electro-adsorption, electro-dialysis (ED) and continuous electro-desalination (EDI) technologies. The market share of the reverse osmosis technology is increasingly high with improvement of membrane performance and application of energy recovery devices, whereas the thermal seawater desalination technology such as multi-stage flash (MSF), multi-effect distillation (MED) and vapor compression (VC) has tended to be mature. Other relevant new technologies are also continually developed, e.g. forward osmosis (FO), gas hydrate method, membrane distillation and humidification-dehumidification methods and the like can be used as referenced technologies for aqueous electrolyte solution separation, but the above technologies exist the technical problems of high energy consumption, low fresh water recovery rate, process complexity and the like.

Currently, in most water-based solution desalination processes, solvent water is extracted from a water-based solution, and the remaining high-concentration solution serving as concentrated water is discharged, so that the recovery rate of low-concentration electrolyte is generally less than 75%; for the ion separation technology of electrolyte with higher concentration, the recovery rate of fresh water is less than 50%; if the ion concentration of a concentrated solution needs to be further increased, namely the recovery rate of fresh water is improved, a series of problems caused by osmotic pressure rise, scaling of inorganic insoluble sediments and boiling point elevation must be paid more attention; the osmotic pressure rise directly leads to increase of operating pressure of a reverse osmosis system, and the concentration rise leads to a serious scaling trend; the boiling point elevation directly leads to increase of the temperature difference between stages of multi-stage flash or effects of multi-effect distillation, thus reducing the effective water making ratio and the effective utilization rate of energy; furthermore, the recovery rate of fresh water is decreased and the adding quantity of a scale inhibitor is increased with the increasing of the scaling of the inorganic insoluble sediments, thus increasing the equipment and operating costs and worsening the economical efficiency and environment friendliness. In the electro-adsorption separation technology, anions and cations are enriched on an electrode from the water-based solution so that the passing ions in the water-based solution are reduced to realize desalination, and the ions enriched on the electrode are desorbed to form concentrated water for discharging. The present electro-adsorption desalination mainly concerns the physical property of an electrode plate itself, and only when the electrode plate has a larger specific surface, namely in the presence of electrification and an electrolyte solution, the electrode shows higher adsorptive capacitance, so that the purpose of adsorbing a large amount of ions is achieved. However, these technologies have extremely high requirement for the performance of the electrode, otherwise, the adsorption capability is low, so that the application ranges of these technologies are directly limited.

It is very necessary to seek a water-based solution separation method which may treat different concentrations electrolyte solutions through ion separation technology, has higher fresh recovery rate, can continuously operate and is satisfying on the aspects of economy, technology and environment friendliness.

### SUMMARY OF THE INVENTION

To solve the technical problems in the prior art, the present invention provides an ion separation device formed by a magnetic field and ion exchange membranes, and an ion separation method thereof. According to the right hand rule that conductors moving in a magnetic field may generate current, a flowing ion-containing electrolyte solution may be regarded as innumerable parallel conductors continuously cutting magnetic lines, thus generating current, namely anions and cations move towards opposite directions; due to flowing of main fluid is isolated by a partition, the main fluid moves reversely after flowing through the partition and arriving at an end surface enclosure; the directions of the magnetic lines are identical, and the moving directions of the conductors are opposite, so that the induced current directions at two ends of the partition are opposite; and anion exchange membranes and cation exchange membranes matched with the movement of anions and cations respectively in the separation device play a role in selectively transmitting ions and also play a role in isolating two kinds of fluid, so that anions or cations are coupled with cations or anions in two kinds of fluid adjacent to the partition in opposite directions, the coupled ions respectively enter concentrated fluid on two sides, electrical neutralization is completed in the concentrated solution on two sides, and continuous separation of anions and cations is realized. The present invention aims to provide a device and a method which have the advantages that continuous operation can be achieved, the system recovery rate and the ion separation efficiency are high, the operating pressure, the temperature change influence and the power consumption are low, the concentration of concentrated solution electrolyte is only limited by the solubility of the electrolyte and equipment is convenient to start and stop. The present invention has the advantages which may not be achieved by other membrane methods and thermal distillation desalination methods.

To achieve the above purposes, the technical scheme adopted by the present invention is to provide an ion separation device formed by a magnetic field and ion exchange membranes. The device includes a magnetic field formed by a magnetic pole I and a magnetic pole II, an anion exchange membrane I and a cation exchange membrane I are arranged on two sides of a stock solution passage I, a cation exchange membrane II and an anion exchange membrane II are correspondingly arranged on two sides of a stock solution passage II, a partition is arranged between the stock solution passage I and the stock solution passage II in opposite flowing directions, one side of a concentrated solution passage I corresponds to the anion exchange membrane I and the cation exchange membrane II, and a concentrated solution passage II corresponds to the cation exchange membrane I and the anion exchange membrane II.

The present invention further provides an ion separation method using the above ion separation device. The process of the ion separation method includes: in the presence of a magnetic field, anions of a flowing electrolyte solution pass through the anion exchange membranes while cations of the flowing electrolyte solution pass through the cation exchange membranes, anions of an electrolyte solution in the adjacent passages pass through the anion exchange membranes while cations of the electrolyte solution in the adjacent passage pass through the cation exchange membranes, and neutralization is respectively completed in the high-concentration solution on two sides, so that continuous ion separation is realized.

The present invention has the effects: according to the ion separation device formed by a magnetic field and ion exchange membranes, main fluid moves forwardly and reversely in sequence in the ion separation device, and the induced current directions of fluid in two kinds of flowing directions are opposite, so that the electrical properties of charged ions transferred to the same side are opposite; the electrical properties and equivalent numbers of anions/cations and cations/anions of forward and reverse fluid in each fluid on two sides are neutralized due to the selective permeability of the anion and cation exchange membranes and the isolation of the fluid, and the ions in the forward and reverse fluid are transferred to the concentrated liquid on the side, so that the ion concentration of the main fluid is reduced, and the ion separation efficiency can be controlled by circulation, intensity of the magnetic field and flow rate. The present invention is not influenced by boiling point elevation and osmotic pressure rise, but is only influenced by the number of hydrated ions and the solubility of saturated solvend. The ion removal rate can be continuously and steplessly adjusted; by comparing the concentrated solution on two sides with the stock solution, the ions can be concentrated by over 4 times, which is an aspect different from the existing deionization technology; and on the other hand, the treatment cost and the energy consumption are low.

The present invention has the characteristics: solvend ions can be directly separated from the solution, rather than leaving the concentrated solution after the solvent is extracted; different from electro-dialysis and continuous electro-desalination, continuous separation of anions and cations is realized in the absence of an electrode, and the system does not involve oxidation-reduction reaction; and also different from electro-adsorption, desorption is not needed.

### BRIEF DESCRIPTION OF THE DRAWINGS

FIG. 1 is a schematic diagram of an ion separation device formed by a magnetic field and ion exchange membranes in the present invention;

FIG. 2 is a structural schematic diagram of an ion separation chamber in FIG. 1;

FIG. 3 is an arrangement diagram of ion exchange membranes on A-A and B-B sections of the ion separation chamber of FIG. 2;

FIG. 4 is a flowing schematic diagram of main fluid;

FIG. 5 is a flowing schematic diagram of the solutions on two sides;

FIG. 6 is a schematic diagram of two-dimensional ion transfer;

FIG. 7 is a schematic diagram of three-dimensional ion transfer;

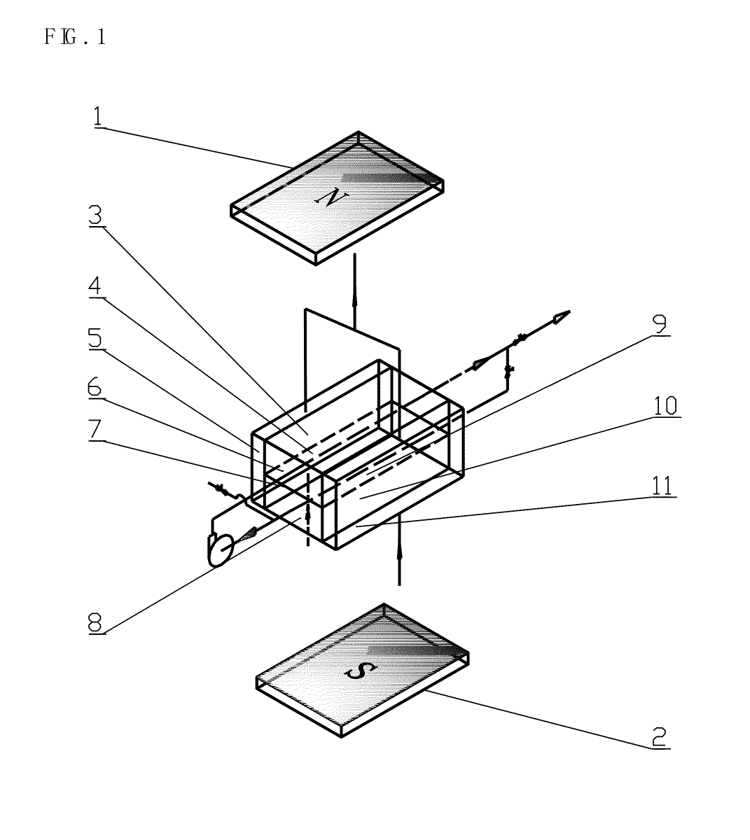

In FIG. 1:

1 represents magnetic pole I; 2 is a magnetic pole II; 3 is a anion exchange membrane I; 4 is a cation exchange membrane I; 5 is a concentrated solution passage I; 6 is a stock solution passage I; 7 is a partition; 8 is a stock solution passage II; 9 is a cation exchange membrane II; 10 is a anion exchange membrane II; 11 is a concentrated solution passage II.

### DETAILED DESCRIPTION OF THE INVENTION

An ion separation device and an ion separation method formed by a magnetic field and ion exchange membranes of the present invention will be described in detail in combination with the accompanying drawings and embodiments.

The principle of the present invention is: flowing liquid or fluid conductors generate induced current under the action of a magnetic field, that is, anions and cations move oppositely, and neutralization of anions and cations is finally completed on two sides due to the isolation and ion selective permeation effects of ion exchange membranes and the forward and reverse movement of main fluid, so that dissoluble ions of the main fluid are continuously removed.

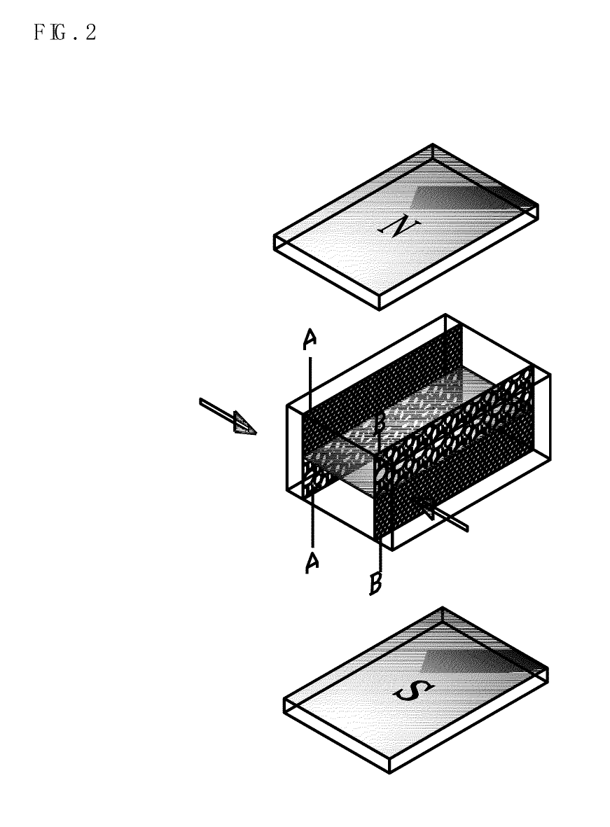

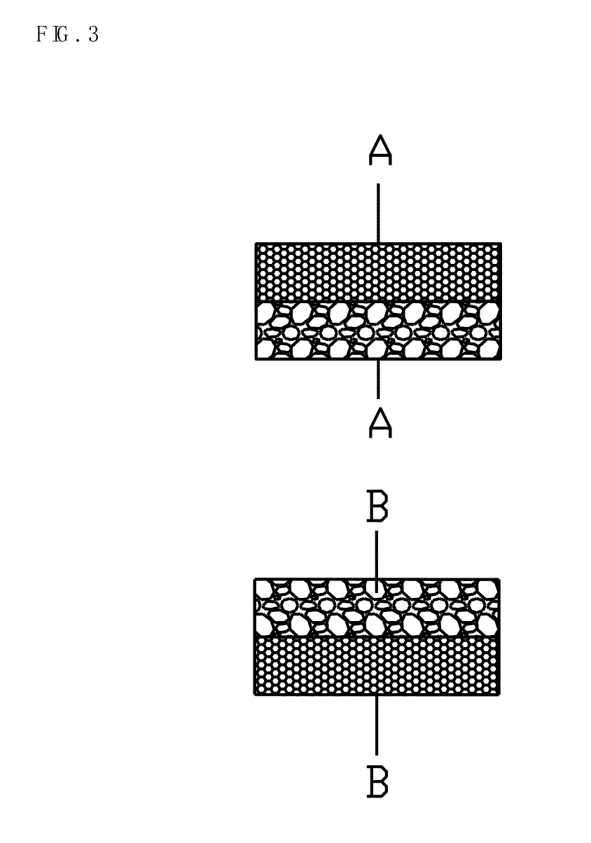

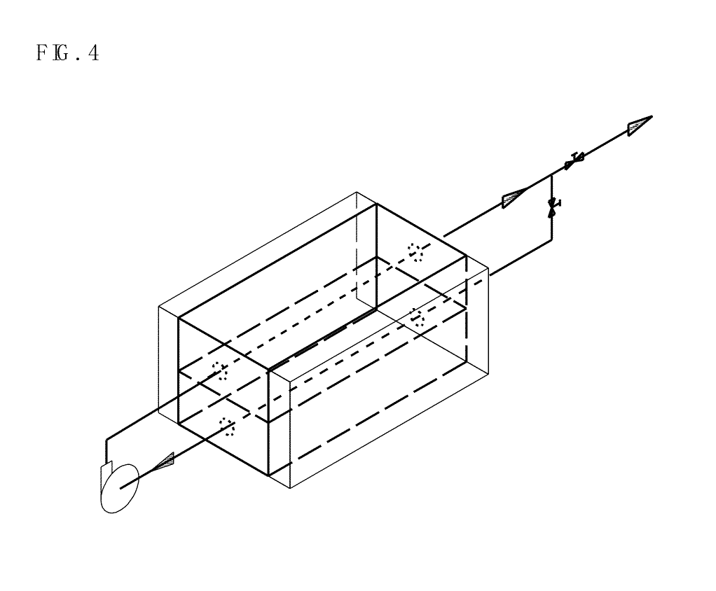

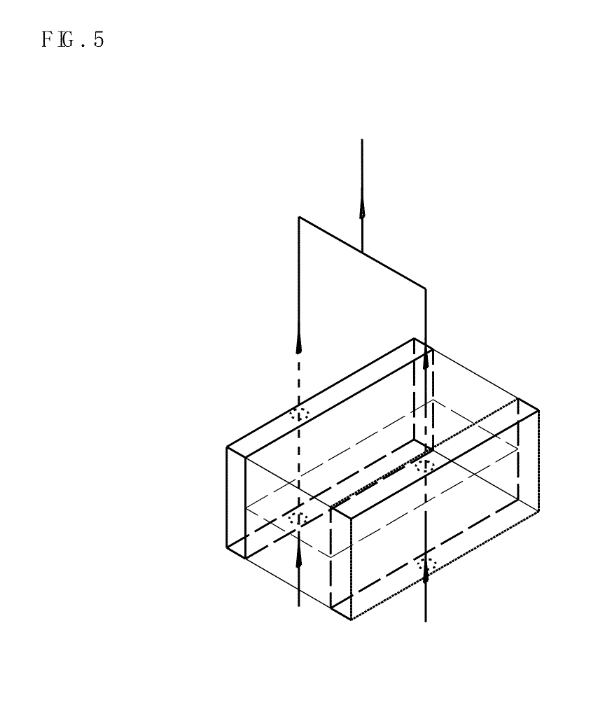

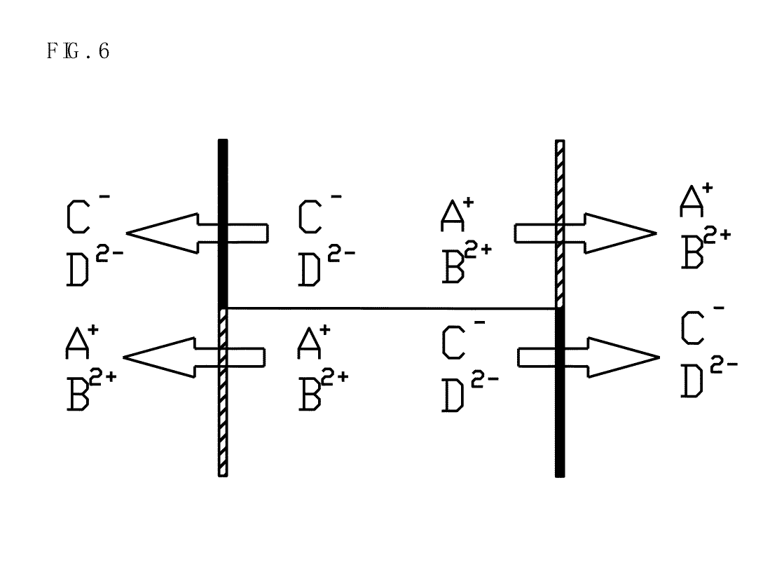

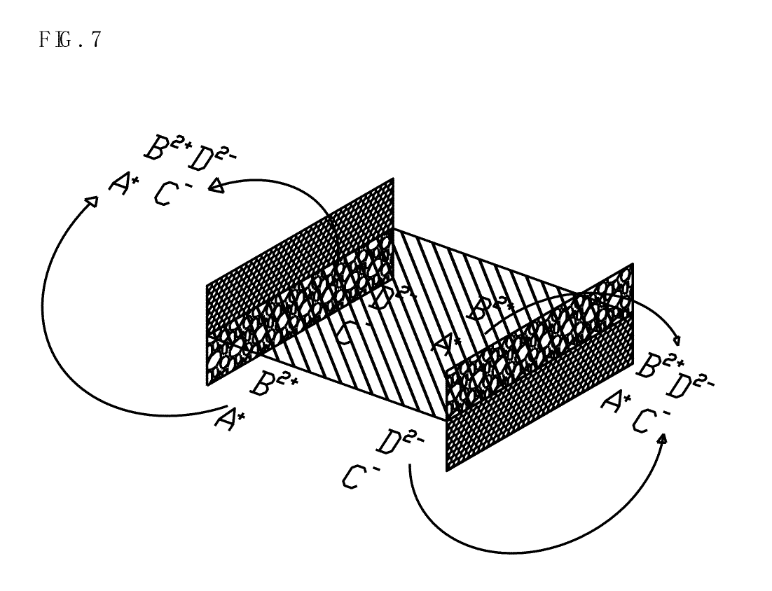

As shown in FIG. 1 to FIG. 7, the present invention provides an ion separation device formed by a magnetic field and ion exchange membranes. The device includes a magnetic field formed by a magnetic pole I 1 and a magnetic pole II 2, an anion exchange membrane I 3 and a cation exchange membrane I 9 are arranged on two sides of a stock solution passage I 6, a cation exchange membrane II 4 and an anion exchange membrane II 10 are correspondingly arranged on two sides of a stock solution passage II 8, a partition 7 is arranged between the stock solution passage I 6 and the stock solution passage II 8 in opposite flowing directions, one side of a concentrated solution passage I 5 corresponds to the anion exchange membrane I 3 and the cation exchange membrane II 4, and a concentrated solution passage II 11 corresponds to the cation exchange membrane I 9 and the anion exchange membrane II 10.

Forward flowing and reverse flowing of the main fluid are magnetic line cutting movement, and concentrated fluid on two sides flows in parallel to magnetic lines.

Anions and cations in the same passage are respectively transferred to the concentrated solution on two sides, while corresponding charged ions with opposite electrical properties in the reverse flowing passages are transferred to the concentrated solution on the same side.

The process of an ion separation method using the ion separation method of the ion separation device formed by a magnetic field and ion exchange membranes includes: in the presence of a magnetic field, anions of a flowing electrolyte solution pass through the anion exchange membranes while cations of the flowing electrolyte solution pass through the cation exchange membranes, anions of an electrolyte solution in the adjacent passages pass through the anion exchange membranes while cations of the electrolyte solution in the adjacent passages pass through the cation exchange membranes, and neutralization is respectively completed in the high-concentration solution on two sides, so that continuous ion separation is realized.

### Embodiment 1

An ion separation device formed by a magnetic field and ion exchange membranes in the present invention includes a magnetic field formed by a magnetic pole I 1 and a magnetic pole II 2 of a neodymium iron boron magnet, an anion exchange membrane I 3 and a cation exchange membrane I 9 are arranged on two sides of a stock solution passage I 6, a cation exchange membrane II 4 and an anion exchange membrane II 10 are correspondingly arranged on two sides of a stock solution passage II 8, a partition 7 is arranged between the stock solution passage I 6 and the stock solution passage II 8 in opposite flowing directions, one side of a concentrated solution passage I 5 corresponds to the anion exchange membrane I 3 and the cation exchange membrane II 4, and a concentrated solution passage II 11 corresponds to the cation exchange membrane I 9 and the anion exchange membrane II 10, wherein the anion exchange membranes are polyethylene heterogeneous anion exchange membranes, and the cation exchange membranes are polyethylene heterogeneous cation exchange membranes. Main fluid does reverse magnetic line cutting movement, the concentrated solution on two sides moves in parallel to magnetic lines, and ions in the main fluid are continuously transferred to the concentrated solution.

### Embodiment 2

An ion separation device formed by a magnetic field and ion exchange membranes in the present invention includes a magnetic field induced by an ion separation chamber outer ring electromagnetic coil, an anion exchange membrane I 3 and a cation exchange membrane I 9 are arranged on two sides of a stock solution passage I 6, a cation exchange membrane II 4 and an anion exchange membrane II 10 are correspondingly arranged on two sides of a stock solution passage II 8, a partition 7 is arranged between the stock solution passage I 6 and the stock solution passage II 8 in opposite flowing directions, one side of a concentrated solution passage I 5 corresponds to the anion exchange membrane I 3 and the cation exchange membrane II 4, and a concentrated solution passage II 11 corresponds to the cation exchange membrane I 9 and the anion exchange membrane II 10, wherein the anion exchange membranes are polyethylene heterogeneous anion exchange membranes, and the cation exchange membranes are polyethylene heterogeneous cation exchange membranes. Main fluid does reverse magnetic line cutting movement, the concentrated solution on two sides moves in parallel to magnetic lines, and ions in the main fluid are continuously transferred to the concentrated solution.

### Embodiment 3

According to an ion separation method formed by a magnetic field and ion exchange membranes, an aqueous electrolyte solution containing conductive ions forwardly and reversely passes through a permanent magnetic field in sequence at a certain velocity, an anion exchange membrane I 3 and a cation exchange membrane I 9 are arranged on two sides of a stock solution passage I 6, a cation exchange membrane II 4 and an anion exchange membrane II 10 are correspondingly arranged on two sides of a stock solution passage II 8, a partition 7 is arranged between the stock solution passage I 6 and the stock solution passage II 8 in opposite flowing directions, one side of a concentrated solution passage I 5 corresponds to the anion exchange membrane I 3 and the cation exchange membrane II 4, and a concentrated solution passage II 11 corresponds to the cation exchange membrane I 9 and the anion exchange membrane II 10, wherein the anion exchange membranes are polyethylene heterogeneous anion exchange membranes, and the cation exchange membranes are polyethylene heterogeneous cation exchange membranes.

The ion removal process includes: a 100000 mg/L sodium chloride aqueous solution is delivered to a main fluid passage under the pressure of 0.3 MPa, the volume of the concentrated solution on two sides is 1/4 of the volume of main fluid, and the salt content of the main fluid is reduced to 500 mg/L 5 minutes after the main body solution flows in a completely closed circulation manner.

### Embodiment 4

According to an ion separation method formed by a magnetic field and ion exchange membranes, an aqueous electrolyte solution containing conductive ions forwardly and reversely passes through a coil induced magnetic field in sequence at a certain velocity, an anion exchange membrane I 3 and a cation exchange membrane I 9 are arranged on two sides of a stock solution passage I 6, a cation exchange membrane II 4 and an anion exchange membrane II 10 are correspondingly arranged on two sides of a stock solution passage II 8, a partition 7 is arranged between the stock solution passage I 6 and the stock solution passage II 8 in opposite flowing directions, one side of a concentrated solution passage I 5 corresponds to the anion exchange membrane I 3 and the cation exchange membrane II 4, and a concentrated solution passage II 11 corresponds to the cation exchange membrane I 9 and the anion exchange membrane II 10, wherein the anion exchange membranes are polyethylene heterogeneous anion exchange membranes, and the cation exchange membranes are polyethylene heterogeneous cation exchange membranes.

The ion removal process includes: a 30000 mg/L sodium chloride aqueous solution is delivered to a main fluid passage under the pressure of 0.2 MPa, the volume of the concentrated solution on two sides is 1/5 of the volume of main fluid, and the salt content of the main fluid is reduced to 200 mg/L 7 minutes after the main body solution flows in a 3/4 volume flow rate circulation manner.

The embodiments of the present invention have the advantages and positive effects of high ion separation efficiency, process simplicity, low energy consumption and the like.

1. An ion separation device formed by a magnetic field and ion exchange membranes, wherein the device comprises a magnetic field formed by a magnetic pole I (1) and a magnetic pole II (2), an anion exchange membrane I (3) and a cation exchange membrane I (9) are arranged on two sides of a stock solution passage I (6), a cation exchange membrane II (4) and an anion exchange membrane II (10) are correspondingly arranged on two sides of a stock solution passage II (8), a partition (7) is arranged between the stock solution passage I (6) and the stock solution passage II (8) in opposite flowing directions, one side of a concentrated solution passage I (5) corresponds to the anion exchange membrane I (3) and the cation exchange membrane II (4), and a concentrated solution passage II (11) corresponds to the cation exchange membrane I (9) and the anion exchange membrane II (10).

2. The ion separation device formed by a magnetic field and ion exchange membranes of claim 1, wherein the magnetic field is a permanent magnetic field or a coil induced magnetic field.

3. The ion separation device formed by a magnetic field and ion exchange membranes of claim 1, wherein main fluid flows to cut magnetic lines.

4. The ion separation device formed by a magnetic field and ion exchange membranes of claim 1, wherein the main fluid flows forwardly and reversely do magnetic line cutting movement in sequence for multiple times.

5. The ion separation device formed by a magnetic field and ion exchange membranes of claim 1, wherein the solutions on two sides flows in parallel to the magnetic lines.

6. The ion separation device formed by a magnetic field and ion exchange membranes of claim 1, wherein the main fluid flows partial or complete circulation.

7. The ion separation device formed by a magnetic field and ion exchange membranes of claim 1, wherein the anion exchange membrane and the cation exchange membrane in each main fluid passage are arranged on two sides.

8. The ion separation device formed by a magnetic field and ion exchange membranes of claim 1, wherein ion exchange membranes with opposite electrical properties are sequentially placed on the same side of two adjacent opposite directions.

9. The ion separation device formed by a magnetic field and ion exchange membranes of claim 1, wherein an ion transfer device for transferring ions from an electrolyte solution to two sides transfers charged ions with opposite electrical properties in opposite directions.

10. The ion separation device formed by a magnetic field and ion exchange membranes of claim 1, wherein anions and cations in the same passage are respectively transferred to the solutions on two sides, and corresponding charged ions with opposite electrical properties in a reverse flowing passage are transferred to the solutions on the same side.

11. The ion separation device formed by a magnetic field and ion exchange membranes of claim 1, wherein the ion separation device can be used for removing or concentrating ions in the main fluid of the electrolyte solution.

12. An ion separation method formed by a magnetic field and ion exchange membranes according to claim 1, wherein the process of the ion separation method comprises: in the presence of a magnetic field, anions of a flowing electrolyte solution pass through the anion exchange membranes while cations of the flowing electrolyte solution pass through the cation exchange membranes, anions of an electrolyte solution in the adjacent passages pass through the anion exchange membranes while cations of the electrolyte solution in the adjacent passages pass through the cation exchange membranes, and neutralization is finally completed in the high-concentration solution on two sides respectively, so that continuous ion separation is realized.

13. The method of claim 12, wherein the method comprises a step of realizing reverse transfer of anions and cations in the magnetic field through flowing liquid conductors.

14. The method of claim 12, wherein the method comprises a step of providing a device suitable for transferring anions and cations.

15. The ion separation method formed by a magnetic field and the ion exchange membranes of claim 12, wherein the method comprises a step of completing electrical neutralization of cations and anions in the solutions on two sides.
